(19) United States
(12) Patent Application Publication
(10) Pub. No.: US 2020/0227923 A1
(43) Pub. Date: Jul. 16, 2020

(54) SYSTEMS AND METHODS FOR COMBINING POWER OUTPUT OF MULTIPLE POWER SOURCES

(71) Applicant: Arjun K. Agarwal, MorrisPlains, NJ (US)

(72) Inventor: Arjun K. Agarwal, MorrisPlains, NJ (US)

(21) Appl. No.: 16/742,312

(22) Filed: Jan. 14, 2020

Related U.S. Application Data
(60) Provisional application No. 62/793,229, filed on Jan. 16, 2019.

(51) Int. Cl. H02J 5/00; H02J 1/10; H02J 1/12

(52) U.S. Cl. CPC H02J 5/00; H02J 1/12; H02J 1/106

(57) ABSTRACT

Implementations of the present disclosure provide method and system for combining power output of multiple power sources. The system includes a combiner unit that receives a first DC power from a variable DC power source and transmits the first DC power as a DC power outputted to a powered device. The system also includes an inverter unit that receives AC power and converts the AC power to a second DC power different from the first DC power. The system also includes a monitoring/control unit that tracks and measures the DC power outputted to the powered device. The monitoring unit determines that the DC power outputted to the powered device is below a threshold level of a hundred percent, and upon this determination the monitoring unit sends a command signal to a combiner unit that combines the second DC power with the first DC power such that the combined DC power is delivered to the power device at the threshold level of hundred percent.

### CROSS-REFERENCE TO RELATED APPLICATION

This disclosure claims the benefit under 35 U.S.C. § 119(e) of co-pending, commonly-assigned U.S. Provisional Patent Application No. 62/793,229 filed Jan. 16, 2019, which is hereby incorporated by reference herein in its entirety.

### FIELD OF USE

This disclosure relates generally to power control system, and more particularly, to methods and systems for combining power output of multiple power sources.

### BACKGROUND OF THE DISCLOSURE

The background description provided herein is for the purpose of generally presenting the context of the disclosure. Work of the inventors hereof, to the extent the work is described in this background section, as well as aspects of the description that does not otherwise qualify as prior art at the time of filing, are neither expressly nor impliedly admitted to be prior art against the present disclosure.

Typically, solar or other variable power sources are used to operate a consumer or industrial powered device, for example a Fan. Renewable energy from the variable power source is not always sufficient to insure consistent operation of the powered device. Currently, systems exists that switch power from the variable power source to other power sources when the renewable energy cannot meet the load demand required for full design capability performance of the powered device. However, today no such system exists that blends the power from the variable power source with other power sources to provide for a constant maximum power output to the powered device.

### SUMMARY

Implementations described herein provide a power control system for blending varying voltages creating a constant voltage to provide continuous maximum power to the powered device.

In one implementation, the power control system includes a combiner unit configured to receive a first DC power from a variable DC power source and transmit the first DC power as the DC power outputted to the powered device. The power control system also includes an inverter unit coupled to the combiner unit. The inverter unit is configured to receive AC power and convert the AC power to a second DC power different from the first DC power. The power control system also includes a monitoring/control unit coupled to the combiner unit. The monitoring unit is configured to monitor the DC power outputted to the powered device. The monitoring unit determines that the DC power outputted to the powered device is below a threshold level of a hundred percent, and upon the determination the control unit sends a command signal to the combiner unit to allow the second DC power from the inverter unit. Upon receipt of the signal, the combiner unit allows the second DC power outputted from the inverter unit and combines the second DC power with the first DC power such that the combined DC power is delivered to the power device at the threshold level of hundred percent.

### BRIEF DESCRIPTION OF THE DRAWINGS

Further features of the disclosure, its nature and various potential advantages will become apparent upon consideration of the following detailed description, taken in conjunction with the accompanying drawings, in which like reference characters refer to like parts throughout, and in which:

FIG. 1 is a block diagram of an example of a power output system in accordance with an implementation of the present disclosure;

FIG. 2 is an example of a graphical representation of the power output of the system of FIG. 1, in accordance with an implementation of the present disclosure; and

FIG. 3 is a high-level flow chart for a process for combing power output of multiple power sources to utilizing the system of FIG. 1 in accordance with an implementation of the present disclosure.

### DETAILED DESCRIPTION

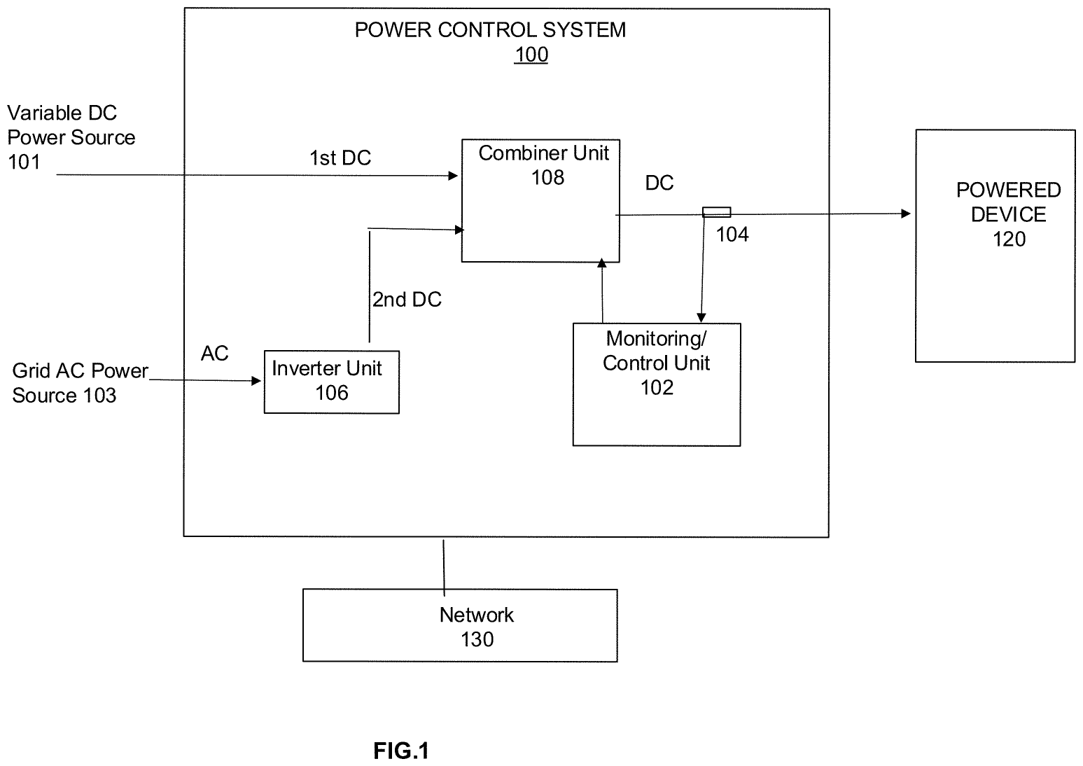

FIG. 1 is a block diagram of an example of a power control system (system) 100 according to one implementation of the present disclosure. As illustrated, the system 100 includes a monitoring/control unit 102, a sensor 104, an inverter unit 106, and a combiner unit 108. In one implementation, a variable DC power source 101 provides a first (1^{st}) DC power, which is delivered to the combiner unit 108, which functions to transmit this 1^{st} DC power as a DC power to a powered device (e.g. Fan) 120. The variable DC power source 101 is a renewable energy power source providing renewable energy. Some examples of renewal energy include solar, wind, turbine etc.

In one implementation, a grid AC power source 103 provides an AC power to the inverter unit 106, which functions to convert the AC power into a DC power (a.k.a. 2^{nd} DC power). The monitoring unit 102 functions to monitor the DC power being delivered to the powered device 120. In one implementation, the monitoring unit 102 tracks and measures the DC power delivered to the powered device 120. In one example the monitoring unit 102 monitors the DC power via the sensor 104. In one implementation, the monitoring unit 102 monitors the DC power to check whether the DC power being delivered to the powered device 120 is at a threshold level of hundred percent (100%). In one implementation, the monitoring unit 102 determines that the DC power being delivered to the powered device 120 is lower than the threshold level of 100%. Upon this determination, the monitoring unit 102 then sends a command signal to the combiner unit 102 to allow the 2^{nd} DC power into the combiner unit 102. In one example, the 2^{nd} DC power is a line voltage which is shut off and only turned on by the combiner unit 108. The combiner unit 108 combines the 1^{st} DC power with the 2^{nd} DC power resulting in a combined DC power outputted to the power device 120 at the threshold level of 100%. Thus, the system ensures that the DC power delivered to the powered device 120 always remain at the threshold level of 100%.

Upon this determination, the monitoring unit 102 then sends a command signal to the combiner unit 102 to allow the 2^{nd} DC power into the combiner unit 102. In one example, the 2^{nd} DC power is a line voltage which is shut off and only turned on by the combiner unit 108. The combiner unit 108 combines the 1^{st} DC power with the 2^{nd} DC power resulting in a combined DC power outputted to the power device 120 at the threshold level of 100%. Thus, the system ensures that the DC power delivered to the power device 120 always remain at the threshold level of 100%.

In some implementations, the system 100 can be programmed either locally or remotely using a network 130. In one implementation, a logic program is developed to work with the components of the system 100 to combine or blend various voltages to achieve constant DC power at the threshold level of 100%.

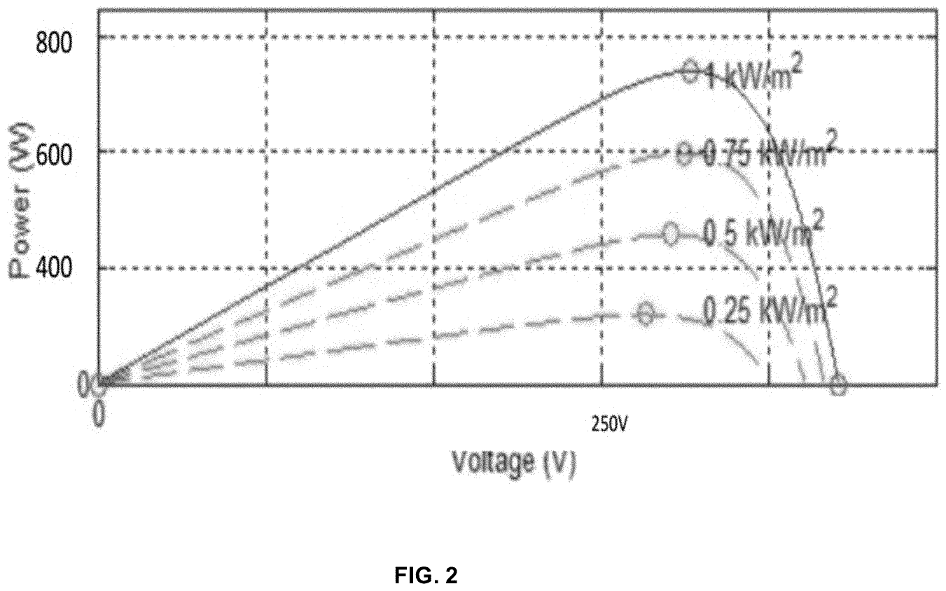

FIG. 2 is an example of graphical representation of the power output of the system of FIG. 1, in accordance with an implementation of the present disclosure. In one example, the variable DC Power Source 101 is a solar power source, the 1^{st} DC power is solar power, and the powered device 120 is a fan. In one implementation, the 0.5 kW/m² to 1 kW/m² is the solar power at 100% threshold level received from the solar power source. At solar power less than 0.5 kW/m², power from the grid AC source is shared from 1% to 50% on 0.25 kW/m². In some examples, at 12 PM, the solar power output—200% is available to the fan, at 11 AM & 2 PM, the solar power output—140% available to the fan, at LOAM & 3 PM, the solar power output—100% available to the fan, at 9 AM & 4 PM solar power output—75% available to the fan and 8 AM & 5 PM solar power output—50% available to the fan. In one example, solar power to the fan is maximized by adding solar panels. Additionally, in one example, the system 100 functions to run at the peak power points (o dots shown in FIG. 2) approximately all the time.

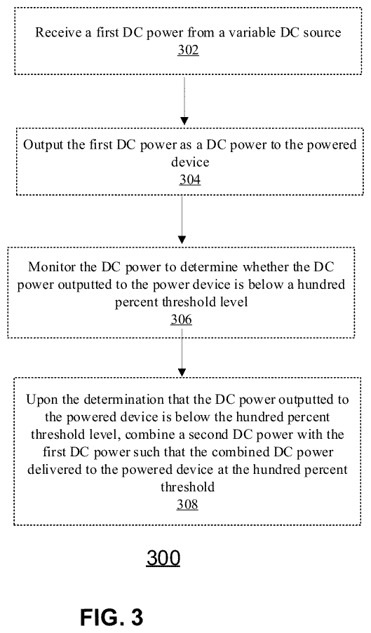

FIG. 3 is an example logic flow diagram of method 300 for combing power output of multiple power sources to utilizing the system of FIG. 1 in accordance with an implementation of the present disclosure.

At block 302, receive a first (1^{st}) DC power from a variable DC source. As discussed above, a variable DC power source provides the 1^{st} DC power. At block 304, output the 1^{st} DC power as a DC power to a powered device. As discussed above, the 1^{st} DC power is delivered to a powered device (e.g. Fan). At block 304, monitor the DC power to determine whether the DC power outputted to the power device is below a hundred percent (100%) threshold level.

In one implementation, it is determined that the DC power outputted to the powered device is below the hundred percent threshold level. At block 306, upon determination that DC power outputted to the powered device is below the hundred percent threshold level, combine a second DC power with the first DC power such that the combined DC power is delivered to the powered device at the hundred percent threshold level. As discussed above, the second DC power is received from a grid AC power source, which is an AC power converted into the DC power. Accordingly, the DC power received by the powered device remains at the hundred percent threshold level.

While various implementations of the present disclosure have been shown and described herein, such implementations are provided by way of example only. Numerous variations, changes, and substitutions relating to implementations described herein are applicable without departing from the disclosure. It is noted that various alternatives to the implementations of the disclosure described herein may be employed in practicing the disclosure. It is intended that the following claims define the scope of the disclosure and that methods and structures within the scope of these claims and their equivalents be covered thereby.

While the present invention has been described with reference to specific examples, which are intended to be illustrative only and not to be limiting of the invention, changes, additions and/or deletions may be made to the disclosed implementations without departing from the scope of the invention.

While operations are depicted in the drawings in a particular order, this is not to be construed as requiring that such operations be performed in the particular order shown or in sequential order, or that all illustrated operations be performed to achieve the desirable results. The subject matter of this specification has been described in terms of particular aspects, but other aspects can be implemented and are within the scope of the following claims. For example, the actions recited in the claims can be performed in a different order and still achieve desirable results. As one example, the process depicted in FIG. 3 does not necessarily require the particular order shown, or sequential order, to achieve desirable results. In certain implementations, multitasking and parallel processing may be advantageous. Other variations are within the scope of the following claims.

1. A power control system to provide DC power to a powered device comprising:
a combiner unit configured to receive a first DC power from a variable DC power source and transmit the first DC power as the DC power outputted to the powered device;
an inverter unit coupled to the combiner unit, wherein the inverter unit is configured to receive AC power and convert the AC power to a second DC power different from the first DC power;
a monitoring/control unit coupled to the combiner unit, wherein the monitoring unit is configured to monitor the DC power outputted to the powered device; wherein the monitoring unit determines that the DC power outputted to the powered device is below a threshold level of a hundred percent, and upon the determination the control unit sends a command signal to the combiner unit to allow the second DC power from the inverter unit,
wherein upon receipt of the signal, the combiner unit allows the second DC power outputted from the inverter unit and combines the second DC power with the first DC power such that the combined DC power is delivered to the power device at the threshold level of hundred percent.

2. The system of claim 1 having a first input configured to receive the first DC power outputted from the variable DC power source.

3. The system of claim 1 having a second input configured to receive the AC power outputted from the Grid AC power source.

4. The system of claim 1 having an output configured to deliver the combined power to the powered device.

5. The system of claim 1 wherein the variable DC power source is renewable energy provided by one of a solar, wind, turbine or combinations thereof

6. The system of claim 1 wherein the AC power source is a line voltage.

7. The system of claim 1 wherein the monitoring/control unit is programmable.

8. A method to provide DC power to a powered device comprising:
receiving a first DC power from a variable DC power source;
outputting the first DC power as the DC power to the powered device;
monitoring the DC power to determine whether the DC power outputted to the powered device is below a threshold level of a hundred percent; and
upon the determination that the DC power outputted to the powered device is below the threshold level of a hundred percent, combining a second DC power with the first DC power such that the combined DC power is delivered to the powered device at the threshold level of hundred percent.

9. The method of claim 8 wherein the monitoring comprising tracking and measuring the DC power outputted to the powered device.

10. The method of claim 8 further comprising sending a command signal to allow the second DC power to be combined with the first DC power.
